(19) United States
(12) Patent Application Publication
(10) Pub. No.: US 2006/0082935 A1
(43) Pub. Date: Apr. 20, 2006

(54) Charging circuit applicable to uninterruptible power supply

(75) Inventor: Yuan-Fang Lai, Taoyuan Hsien (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Delta Electronics, Inc.

(21) Appl. No.: 11/241,653

(22) Filed: Sep. 30, 2005

(30) Foreign Application Priority Data
Oct. 14, 2004 (TW) 093131145

(51) Int. Cl. H02H 7/00

(52) U.S. Cl. 361/18

(57) ABSTRACT

A charging circuit applicable to an uninterruptible power supply for receiving an input DC voltage and converting the input DC voltage into a desired DC output voltage is provided. The charging circuit includes a voltage divider for receiving the input DC voltage and dividing the input DC voltage into a plurality of fractional voltages, a switch device connected to the voltage divider and having a plurality of switch elements, a transformer having a primary side and a secondary side in which one end of the primary side is connected to the switch device and the other end of the primary side is connected to the voltage divider, a control device for detecting the output DC voltage and generating a plurality of control signals accordingly to enable the switch elements of the switch device to turn on and off alternately, and a smoothing circuit connected to the secondary side of the transformer for rectifying and filtering the output voltage of the transformer to provide the output DC voltage.

### FIELD OF THE INVENTION

The present invention is related to a charging circuit, and more particularly to a charging circuit applicable to an uninterruptible power supply.

### BACKGROUND OF THE INVENTION

During the operation of an electronic communication system, a clean and continual power supply is a sine qua non for maintaining normal performance. However, the contemporary public electric power supply system is likely to be degenerated by the breakdown and short circuit occurred to the power lines. Therefore, uninterruptible power supply (UPS) has been widely introduced in the client side applications in order to fix the problems of the abnormalities encountered by the input power source. The principle of UPS is based on the rationale by storing electric energy in a rechargeable battery when the commercial power supply is working normally and releasing the electric energy from the rechargeable battery for use by a load when the commercial power supply is malfunctioned. The current uninterruptible power supply roughly falls into three categories: on-line UPS, line-interactive UPS, and off-line UPS. Referring to FIG. 1, a block diagram of an on-line UPS according to the prior art is illustrated. As depicted in FIG. 1, an on-line UPS 1 includes an AC/DC converter 11, an inverter 12, a charging circuit 13, a battery 14, a switch element 15, and a DC/DC converter 16. The AC/DC converter 11 is used to receive a commercial AC voltage Vin and convert the commercial AC voltage Vin into a DC voltage. The charging circuit 13 is electrically connected to the AC/DC converter 11 for converting the DC voltage outputted from the AC/DC converter 11 into a DC voltage Vout2 required by the battery 14 so as to charge the battery 14 accordingly. The inverter 12 is connected to the AC/DC converter 11 for converting the DC voltage outputted from the AC/DC converter 11 or the DC voltage outputted from battery 14 and boosted by the DC/DC converter 16 into a steady and reliable AC output voltage Vout1 for use by a load. The operation of an on-line UPS 1 is carried out in accordance with three different phases:

1. Operation phase 1: When the commercial power supply is supplying power normally, the AC voltage Vin is converted by the AC/DC converter 11 into a DC voltage which is converted by the charging circuit 13 into a DC voltage Vout2 required by the battery so as to charge the battery 14 accordingly. On the other hand, the DC voltage outputted from the AC/ DC converter 11 is converted by the inverter 12 into an AC voltage Vout1 which is outputted to a load through the switch element 15.

2. Operation phase 2: When the inverter 12 is malfunctioned, the switch element 15 switches the power delivery route to a bypass circuit and transmit the commercial power to the load;

3. Operation phase 3: When the commercial power supply is malfunctioned, the battery 14 outputs a DC voltage which is boosted by the DC/DC converter 16 and the boosted DC voltage is transmitted to the inverter 12. The inverter 12 converts the boosted DC voltage into an AC voltage Vout1 and outputs the AC voltage Vout1 to the load through the switching operation of the switch element 15.

Referring to FIG. 2, a systematic diagram of the charging circuit for use in the uninterruptible power supply of FIG. 1 is shown. The charging circuit 13 of FIG. 2 is configured with a flyback topology, in which a control device 131 is employed to control the on/off operation of the switch element Q1 and output a DC voltage Vout2 via the diode D1 and the capacitor C1 located on the secondary side of the transformer T1.

Although the flyback charging circuit 13 is simple in circuit architecture, it is also marred with several disadvantages. Referring to FIG. 3, a characteristic timing diagram illustrating the relationship between the voltage V_{Q1} measured at the node B of the charging circuit of FIG. 2 versus time is shown. When the voltage V_{Q1} at the circuit node B is at a high state, the switch element Q1 will turn on and the current will inject into the primary side of the transformer T1 toward the direction A, and thereby transfer the energy to the secondary side of the transformer T1. When the voltage V_{Q1} at the circuit node B is at a low state, the switch element Q1 will turn off and the current will not changed in the primary side of the transformer T1. Therefore, the energy can't be transferred to the secondary side of the transformer T1. As can be seen from the diagram, the switch element Q1 is turned on during half of the period. Because the charging circuit 13 uses the switch element Q1 as an on/off switch, the current can be directed to the primary side of the transformer T1 in one direction only. Accordingly, only half of the period is used by the transformer T1, which indicates that the utilization of the transformer T1 is low and also the electromagnetic interference (EMI) is aggravated.

As stated above, the conventional flyback charging circuit 13 has a major disadvantage of the low utilization and a high manufacturing cost of the transformer T1. Also, the conventional flyback charging circuit 13 is disfavored due to a serious electromagnetic interference issue. In view thereof, it is an urgent task to develop a charging circuit to address the drawbacks of the conventional charging circuit and reinforce the functionality of the UPS using such charging circuit.

### SUMMARY OF THE INVENTION

A major object of the present invention is to provide a charging circuit applicable to an UPS that removes the drawbacks of the conventional UPS stemming from the low utilization and high manufacturing cost of the transformer and the deteriorated EMI issues.

To this end, a broader aspect of the present invention provides a charging circuit for use in an uninterruptible power supply which receives an input DC voltage and converts the input DC voltage into an output DC voltage. The charging circuit includes a voltage divider for receiving the input DC voltage and dividing the input DC voltage into a plurality of fractional voltages, a switch device connected to the voltage divider and having a plurality of switch elements, a transformer having a primary side and a secondary side in which one end of the primary side is connected to the switch device and the other end of the primary side is connected to the voltage divider, a control device for detecting the output DC voltage and generating a plurality of control signals accordingly to enable the switch elements of the switch device to turn on and off alternately, and a smoothing circuit connected to the secondary side of the transformer for rectifying and filtering the output voltage of the transformer to provide the output DC voltage.

In accordance with the present invention, the charging circuit further includes a compensation circuit connected between the primary side of the transformer and the voltage divider for ensuring the substantial equilibrium of the energy injecting in the primary side of the transformer and the energy discharging from the primary side of the transformer.

In accordance with the present invention, the compensation circuit includes a capacitor.

In accordance with the present invention, the charging circuit is a half-bridge converter.

In accordance with the present invention, the voltage divider is made up of at least two capacitors.

In accordance with the present invention, the switch device includes a first switch element and a second switch element, in which the first switch element and the second switch element is individually controlled by the first control signal and the second control signal issued by the control device so as to turn on and off alternately.

In accordance with the present invention, the charging circuit further includes a current sensor connected to the control device for detecting the variation of the current flowing between the primary side of the transformer and the voltage divider.

Another broader aspect of the present invention provides an uninterruptible power supply including an AC/DC converter, an inverter, a charging circuit, a battery, and a DC/DC converter. The uninterruptible power supply is featured in terms of the charging circuit which includes a voltage divider for receiving an input DC voltage and dividing the input DC voltage into a plurality of fractional DC voltages, a switch device connected to the voltage divider and having a plurality of switch elements, a transformer having a primary side and a secondary side in which one end of the primary side is connected to the switch device and the other end of the primary side is connected to the voltage divider, a control device for detecting an output DC voltage and generating a plurality of control signals accordingly to enable the switch elements of the switch device to turn on and off alternately, and a smoothing circuit connected to the secondary side of the transformer for rectifying and filtering the output voltage of the transformer to provide the output DC voltage.

Now the foregoing and other features and advantages of the present invention will be best understood through the following descriptions with reference to the accompanying drawings, wherein:

### BRIEF DESCRIPTION OF THE DRAWINGS

FIG. 1 is a circuit diagram showing an on-line UPS according to the prior art;

FIG. 2 is a circuit diagram showing a charging circuit of the on-line UPS of FIG. 1;

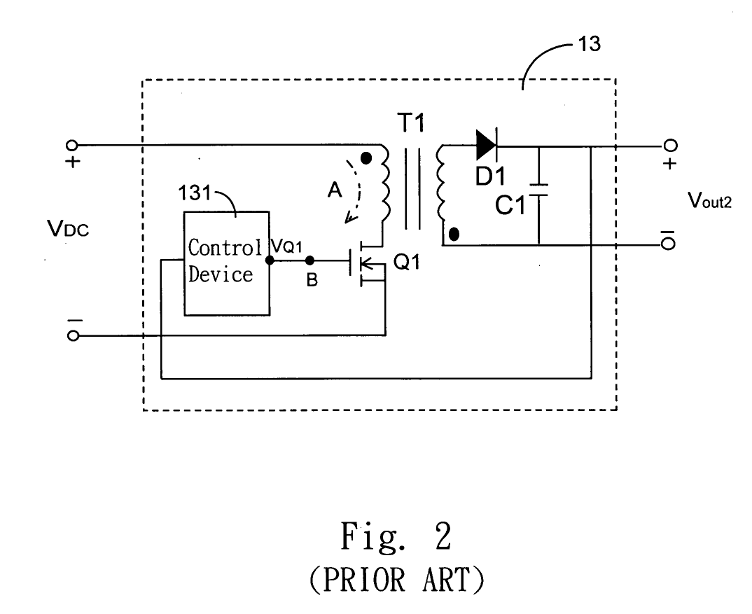

FIG. 3 is a characteristic timing diagram illustrating the relationship of the voltage V_{Q1} measured at the node B versus time;

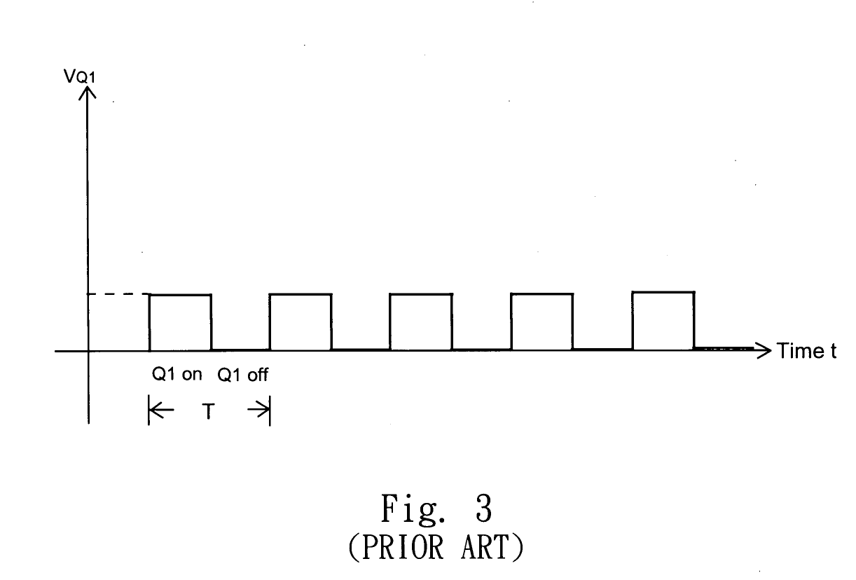

FIG. 4 is a circuit diagram showing a charging circuit of the UPS according to a preferred embodiment of the present invention; and

FIG. 5 is a characteristic timing diagram illustrating the relationship of the first control signal V_{Q2} measured at the node C and the second control signal V_{Q3} measured at the node D versus time.

### DETAILED DESCRIPTION OF THE PREFERRED EMBODIMENT

Several exemplary embodiments embodying the characteristics and advantages of the present invention are intended to be elaborated in the following. It is appreciated that the present invention allows various modifications to be made without departing from the scope of the present invention, and the descriptions and drawings presented herein is used for the purpose of illustration only, but is not intended to be exhaustively interpreted as a constraint on the present invention.

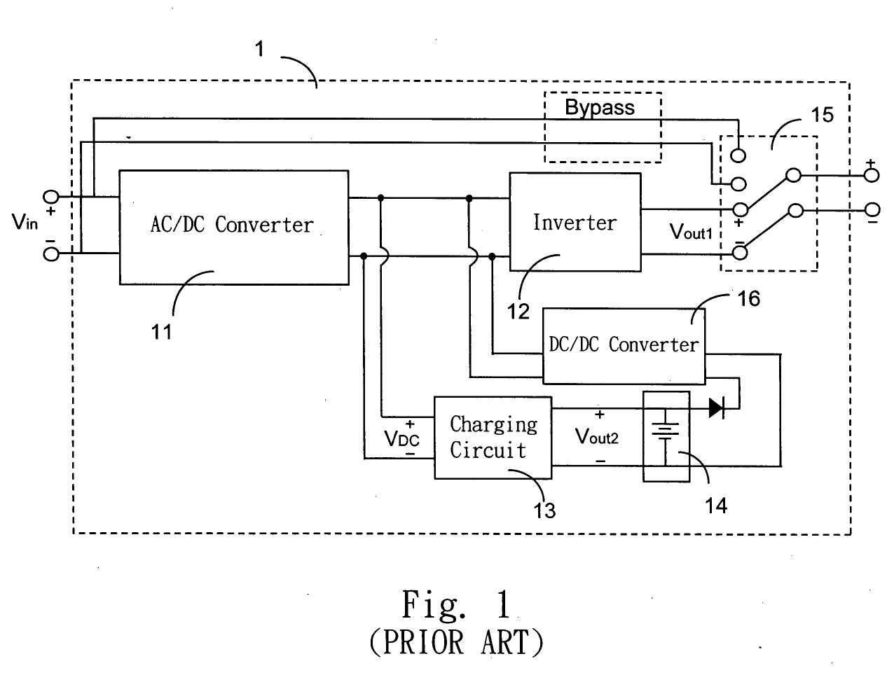

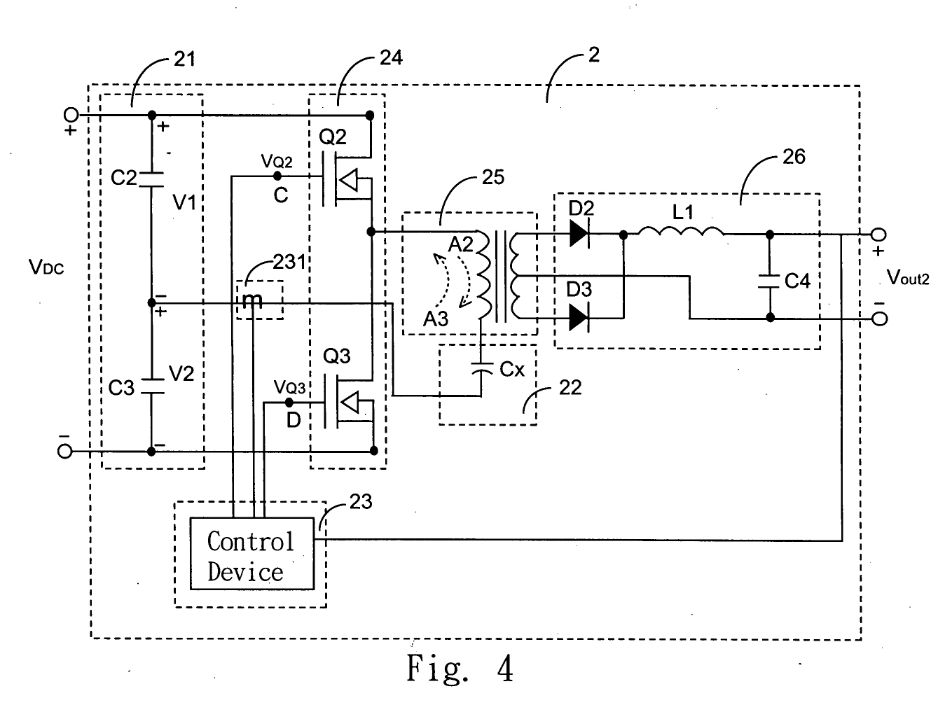

The inventive charging circuit 2 is applicable to an UPS, such as the on-line UPS 1 of FIG. 1, and is used to replace the prior art charging circuit 13. Referring to FIG. 4, an illustrative diagram of the charging circuit according to an embodiment of the present invention is shown. As shown in FIG. 4, the inventive charging circuit 2 is substantially made up of a half-bridge converter which receives a DC voltage V_{DC} from the AC/DC converter 11 of FIG. 1 and converts the DC voltage V_{DC} into a DC voltage Vout2 required by the battery 14 so as to charge the battery 14. The charging circuit 2 further includes a voltage divider 21, a compensation circuit 22, a control device 23, a switch device 24, a transformer 25, and a smoothing circuit 26.

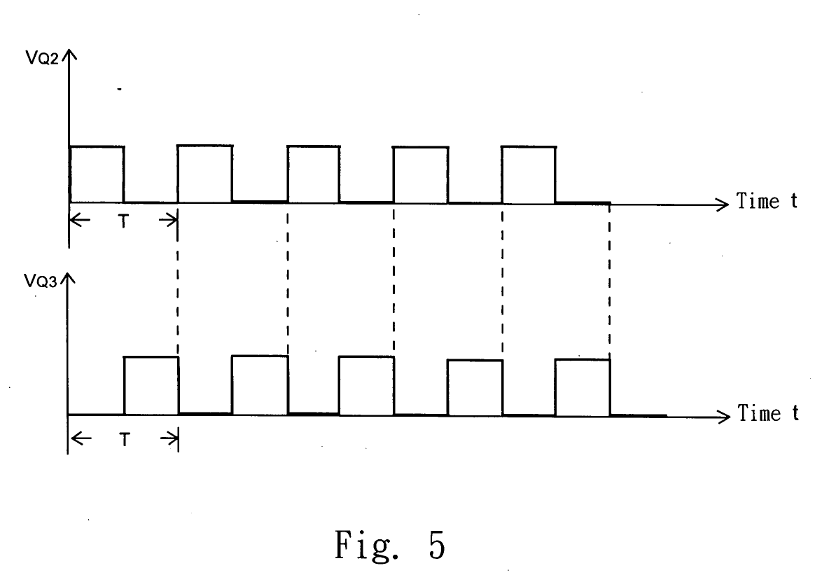

The voltage divider 21 includes a pair of capacitors C2, C3 for dividing the DC voltage V_{DC} into a first fractional voltage V1 and a second fractional voltage V2. The switch device 24 is connected to the voltage divider 21 and includes a first switch Q2 and a second switch Q3. The transformer 25 has a primary side and a secondary side, in which one end of the primary side is connected to the switch device 24 and the other end of the primary side is connected to the voltage divider 21. The control device 23 is connected to the switch device 24 and an output terminal of the charging circuit 2, and is used to detect the variation of the current flowing through the transformer 25 and the voltage divider 21 via a current sensor connected therewith and detect the DC output voltage Vout2 of the charging circuit 2. Accordingly, the control device 23 can send a first control signal V_{Q2} and a second control signal V_{Q3} to control the switching operation of the first switch Q2 and of the second switch Q3, respectively. In the present embodiment, the first switch Q2 and the second switch Q3 of the switch device 24 are switched in a complementary fashion. That is, when the first control signal V_{Q2} is at a high state, the second control signal V_{Q3} will be at a low state and thus the first switch Q2 will turn on while the second switch Q3 is turned off. On the contrary, when the first control signal V_{Q2} is at a low state, the second control signal V_{Q3} will be at a high state and thus the first switch Q2 will turn off while the second switch Q3 is turned on. FIG. 5 is a characteristic timing diagram illustrating the relationship of the first control signal V_{Q2} measured at the node C and the second control signal V_{Q3} measured at the node D versus time. As is known from the diagram of FIG. 5, the first switch Q2 and the second switch Q3 of the switch device 24 are turned on and off alternately within a time period T.

Referring to FIG. 4, when the first switch Q2 is ON, the current injects into the primary side of the transformer 25 following the direction A2. When the second switch Q3 is ON, the current flows out of the primary side of the transformer 25 following the direction A3. By the alternate conduction of the first switch Q2 and the second switch Q3, the current can circulate through the primary side of the transformer 25 in both directions and thus the utilization of the transformer 25 can be improved. In addition, because the capacitance of the capacitors C2 and C3 of the voltage divider 21 is not possible to reach the ideal value as desired, the energy injected into the primary side of the transformer 25 is inconsistent with the energy discharged from the primary side of the transformer 25. To cope with such inconsistency, a compensation circuit 22 connected between the primary side of the transformer 25 and the voltage divider 21 can be optionally added to make compensation for the deficiency of the energy flux, so that the energy injected into the primary side of the transformer 25 and the energy discharged from the primary side of the transformer 25 are substantially equal. Preferably, the compensation circuit 22 is implemented by a capacitor Cx. The two-way current variation occurred to the primary side of the transformer 25 can induce a voltage across the secondary side of the transformer 25 and provide a DC voltage Vout2 to charge the battery 14 (shown in FIG. 1) through the rectification and filtering operation of the smoothing circuit 26.

In some alternative embodiments, the transformer 25 can be made up of a center-tapped transformer and the smoothing circuit 26 can be made up of diodes D2 and D3, inductor L1, and capacitor C4. However, the constitution of the smoothing circuit 26 is not limited to those circuit elements described above.

In conclusion, the inventive charging circuit 2 can enable the current to circulate in the both directions at the primary side of the transformer 25 by the alternate conduction of the first switch Q2 and the second switch Q3. Therefore, the transformer 25 can be fully utilized within any period and thus the utilization of the transformer 25 can be improved. In this manner, the manufacturing cost of the transformer can be lowered compared to the prior art. Besides, the EMI problem can be suppressed dramatically.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A charging circuit applicable to an uninterruptible power supply for receiving an input DC voltage and converting the input DC voltage into an output DC voltage, the charging circuit comprising:
a voltage divider for receiving the input DC voltage and dividing the input DC voltage into a plurality of fractional voltages;
a switch device connected to the voltage divider and having a plurality of switch elements;
a transformer having a primary side and a secondary side, wherein one end of the primary side is connected to the switch device and the other end of the primary side is connected to the voltage divider;
a control device for detecting an output DC voltage and generating a plurality of control signals to enable the switch elements to turn on and off alternately; and
a smoothing circuit connected to the secondary side of the transformer for rectifying and filtering an output voltage of the transformer so as to provide the output DC voltage.

2. The charging circuit as claimed in claim 1 further comprising a compensation circuit connected between the primary side of the transformer and the voltage divider.

3. The charging circuit as claimed in claim 2 wherein compensation circuit comprises a capacitor.

4. The charging circuit as claimed in claim 1 wherein the charging circuit is a half-bridge converter.

5. The charging circuit as claimed in claim 1 wherein the voltage divider comprises at least two capacitors.

6. The charging circuit as claimed in claim 1 wherein the switch device includes a first switch element and a second element respectively driven by a first control signal and a second control signal issued by the control device so as to turn on and off alternately.

7. The charging circuit as claimed in claim 1 further comprising a current sensor connected to the control device for detecting the variation of the current flowing between the primary side of the transformer and the voltage divider.

8. An uninterruptible power supply including an AC/DC converter, an inverter, a charging circuit, a battery, and a DC/DC converter, characterized in that the charging circuit comprising:
a voltage divider for receiving an input DC voltage and dividing the input DC voltage into a plurality of fractional voltages;
a switch device connected to the voltage divider and having a plurality of switch elements;
a transformer having a primary side and a secondary side, wherein one end of the primary side is connected to the switch device and the other end of the primary side is connected to the voltage divider;
a control device for detecting an output DC voltage and generating a plurality of control signals to enable the switch elements to turn on and off alternately; and
a smoothing circuit connected to the secondary side of the transformer for rectifying and filtering an output voltage of the transformer so as to provide the output DC voltage.

9. The uninterruptible power supply as claimed in claim 8 wherein:
the AC/DC converter is used to receive a commercial AC voltage and convert the commercial AC voltage into a DC voltage;
the charging circuit is connected to the AC/DC converter for receiving the DC voltage outputted from the AC/DC converter and converting the DC voltage into the DC voltage required to charge the battery; and
the inverter is connected to the AC/DC converter for converting the DC voltage outputted from the AC/DC converter or a DC voltage which is outputted from the battery and boosted by the DC/DC converter into an AC output voltage for use by a load.

10. The uninterruptible power supply as claimed in claim 8 wherein the charging circuit further comprises a compensation circuit connected between the primary side of the transformer and the voltage divider for ensuring a substantial equilibrium of the energy injecting in the primary side of the transformer and the energy discharging from the primary side of the transformer.

11. The uninterruptible power supply as claimed in claim 10 wherein the compensation circuit comprises a capacitor.

12. The uninterruptible power supply as claimed in claim 8 wherein the charging circuit comprises a half-bridge converter.

13. The uninterruptible power supply as claimed in claim 8 wherein the voltage divider comprises at least two capacitors.

14. The uninterruptible power supply as claimed in claim 8 wherein the switch device includes a first switch element and a second element respectively driven by a first control signal and a second control signal issued by the control device so as to turn on and off alternately.

15. The uninterruptible power supply as claimed in claim 8 wherein the charging circuit further comprises a current sensor connected to the control device for detecting the variation of the current flowing between the primary side of the transformer and the voltage divider.
